(19) United States
(12) Patent Application Publication
(10) Pub. No.: US 2019/0311148 A1
(43) Pub. Date: Oct. 10, 2019

(54) SYSTEM AND METHOD FOR SECURE STORAGE OF ELECTRONIC MATERIAL

(71) Applicant: BLACK GOLD COIN, INC., Las Vegas, NV (US)

(72) Inventor: Marcus Andrade, Fernley, NV (US)

(73) Assignee: BLACK GOLD COIN, INC., Las Vegas, NV (US)

(21) Appl. No.: 15/949,467

(22) Filed: Apr. 10, 2018

(51) Int. Cl. G06F 21/62; H04L 29/06; H04L 29/08; G06F 17/30; H04L 9/06

(52) U.S. Cl. CPC G06F 21/6218; H04L 63/0861; H04L 63/102; H04L 2209/38; G06F 17/30914; G06F 17/30946; H04L 9/0643; H04L 67/1097

(57) ABSTRACT

A secure storage system and method for storing electronic material, e.g., digital files, is disclosed. In the system and method, a digital file is broken down into file fragments and one or more fragments are stored on a distributed ledger or distributed ledgers, and the remaining (one or more) fragments are stored off the distributed ledger, e.g., on a secure server or servers, and/or on a user device or devices. The files that are stored may be biometric or partial biometric files. The files may be encrypted or hashed. The file fragments are preferably unintelligible except when decrypted and fully assembled. For example, theft or copying or hacking of one file fragment will not be effective to steal or copy intelligible, useful information. In some embodiments, the benefits of storage on a distributed ledger or distributed ledgers are combined with the benefits of storage on a secure server or servers (and/or on a user's device or devices) or both.

### CROSS REFERENCE TO RELATED APPLICATION(S)

This application is related to U.S. patent application Ser. No. 15/335,344, filed Oct. 26, 2016, and U.S. patent application Ser. No. 14/940,142, both hereby incorporated by reference herein.

### BACKGROUND OF THE INVENTION

### Field of the Invention

This disclosure relates to systems and methods for secure storage of electronic material.

### Description of the Related Art

Secure storage of electronic material in any form, such as data files, graphics files, image files, video files, biometric files, biometric data, and/or storage of such information whether in file form or not, has always been an issue. With the advent of the internet, anyone around the world can potentially gain unauthorized access into a person's or entity's computer systems no matter how secure. For example, user names and passwords can get stolen, e.g., by clever phishing scams, online viruses, trojans, worms and more. Electronic identity theft and other cyber-crimes are rampant. No one is immune.

There are many conventional methods of fighting unauthorized access. For example, training personnel to recognize scams is one method, but humans are not infallible. Use of security software such as firewalls, anti-virus applications, and many other varieties can provide some protection. However, the more security, the more computer performance can be slowed down, and/or the more difficult to gain access to one's own electronic material.

Another layer of security is known as two-factor or multi-factor verification. Multifactor verification combines two (in two-factor) or more independent (user) credentials. For example, a user may be required to enter a password as well as provide a security token or authentication token (a small hardware device carried by the user) to authorize access. Often such an authentication token is a key fob or smart card. The user often has a PIN (personal identification number) that is needed to make the authentication token work, so as to minimize the chances of a security breach from loss or theft of the authentication token.

Other mechanisms for multi-factor verification include logging into a website and receiving a one-time password on a user's phone or at a user's email address, answering a security question, downloading a VPN client with a valid digital certificate and logging into the VPN before being granted access, and biometric scanning, e.g., fingerprints, retina scan, facial recognition, voice recognition, and other biometric information. See, e.g., U.S. Pat. No. 9,838,388 and U.S. Patent Application Publication No. 2016/0373440 both to Mather and both relating to biometric protocol standards for authentication and secure communication.

Unfortunately, in storing biometric information, the biometric information itself can get stolen. Theft of biometric information could be as devastating, if not more devastating, to an individual as theft of the individual's social security number.

Traditional methods of security have been applied to storage of electronic material on a secure server. However, even these well protected servers can be victims of cyber-attacks.

Currently, systems and methods for securing information related to an individual are lacking in various ways. There is a need in the art for enhanced methods of securing information related to documents and the like. For example, there is a need in the art for enhanced methods related to biometric security.

In recent years, a technology known as “blockchain” has been developed to provide a measure of security, initially for cryptocurrency. Blockchain storage is a kind of distributed ledger and refers to a distributed data -store where users store information on a number of nodes, or a computer network in which users store information on a number of peer network nodes. Peer network means that each user or member of the data store network is connected to the distributed data store by their computers. Each user and their computer is referred to as a “node.” Each node stores the same information and contributes to validation and/or reconciliation of the distributed data store. The information cannot be distorted because the theory of blockchain/distributed ledger is that there are so many users that a cyber-attacker would have to change data stored at a majority or all of the nodes and do so within a short time in order to corrupt the system. The reason one must change a majority of the nodes is that in cryptocurrency each node has the same data, and that data is stored when there is a consensus among the nodes that the data is correct. In the case of cryptocurrency, the blockchain data provide a ledger of all digital transactions of the particular cryptocurrency.

Because of the distributed nature (all nodes storing the same data) of the blockchain/distributed ledger, a blockchain/distributed ledger provides security against modification and/or corruption of such data. However, because a blockchain/distributed ledger stores all transactions and copies those transactions to every node (a ledger), it is very important to efficient operation of the blockchain/distributed ledger that the amount of data stored on the blockchain be limited. Blockchain/distributed ledger storage constraints are very different from secure server storage constraints.

This means, for example, that every node of a particular type of cryptocurrency stores every transaction that has ever occurred of that type of cryptocurrency.

Blockchain/distributed ledger also protects your files, both on the nodes and in transmission, by using blockchain/distributed ledger technology and cryptography to encrypt files. The stored data is typically read only too.

More specifically, all users of blockchain/distributed ledger are connected over the peer-to-peer network. This network is more secure, up to ten times faster, and fifty percent less expensive than the traditional datacenter-based cloud storage solutions. Thus, blockchain/distributed ledger enables users to store data in a secure and decentralized manner. This is done by using blockchain/distributed ledger features such as transaction ledgers, cryptographic hash functions, and public/private key encryption.

The decentralized aspect of blockchain/distributed ledger means that there is no central server to be compromised, and because of the use of client-side encryption, only the end users have complete access to their un-encrypted files and encryption keys.

In some embodiments, distributed data storage based on blockchain technology stores only hashes of its data blocks. And the encrypted and distributed hashes are sufficient to verify the legitimacy or authenticity of the data blocks. Blockchain does not only store data in a distributed and encrypted form, but also provides for a sequential chain in which every block contains a cryptographic hash of the block. This links the blocks and thereby creates a decentralized transaction ledger.

For many data experts, the biggest change that blockchains/distributed ledgers are likely to bring is disintermediation. This is because a well-designed and publicly/privately accessible blockchain/distributed ledger can replace many of the functions that we currently rely on intermediaries for providing a trustworthy trading environment, guarding against fraud and mishandling, ensuring contract compliance, and financial transactions.

Blockchain/distributed ledger's power does not lie just in its heavy encryption; its distribution across a chain of computers also makes blockchain/distributed ledger harder to attack. Blockchain/distributed ledger is a self-verifying storage scheme that can be used to immutably record transactions, ownership or identity, to negotiate and enforce contracts and much more.

The problems, however, with use of blockchain/distributed ledger for storage is that because blockchain/distributed ledger stores a copy of the ledger or transactions on all of nodes, and because no prior transactions can be deleted, the storage needs can quickly become unwieldy. In addition, in order to create various access controls, such as a role-based access control (RBAC), a centralized system is preferably used. However, if one hacks the centralized system, one can gain unauthorized access to the blockchain. In the case of storing sensitive information on the blockchain/distributed ledger, one must provide better security because the blockchain/distributed ledger data cannot be readily deleted.

Aside from the above security procedures, some systems of secure storage have disassembled files and stored them to be reassembled upon request, such as US Patent Application Publication No. 2016/0196218 to Kumar, US Patent Application Publication No. 2017/0272100 to Yanovsky and U.S. Pat. No. 8,694,467 to Sun.

Some have proposed using blockchain but such use is limited and not for file storage, such as Zyskind in “Decentralizing Privacy: Using Blockchain to Protect Personal Data,” and WO 2017/145010 to Wright.

Because of the above constraints on blockchain/distributed ledger and on centralized server storage, neither system is as secure and functional as would be desired.

What is needed is an improved way to securely store electronic material.

### SUMMARY

Some implementations according to the present technology are directed to using software to improve computer functionality by addressing the issue of security. Regarding security, it is desirable to be able to store information associated with an individual (user) and/or information associated with an entity in a secure fashion. The user may be acting on behalf of an entity, such as a private company, a government body, or other entity.

In one or more embodiments, there is a secure storage system and method for storing electronic material, e.g., digital files. In the system and method, a digital file is broken down into file fragments and one or more fragments are stored on a blockchain/distributed ledger or blockchains/distributed ledgers, and the remaining (one or more) fragments are stored off of the blockchain/distributed ledger, e.g., on a secure server or servers, and/or on a user device or devices. The files that are stored may be biometric or partial biometric files and/or any data files. The files may be encrypted or hashed. The file fragments are preferably unintelligible except when decrypted and fully assembled. In some or any embodiments, a fragment or fragments of the file may be stored off line, e.g., in a USB or thumb drive, or other digital storage device which device usually does not have its own CPU. In these and/or any other embodiments, a file fragment or fragments may include all or just portions of a file header.

For example, theft or copying or hacking of one file fragment will not be effective to steal or copy intelligible, useful information.

In some embodiments, the benefits of storage on blockchain(s)/distributed ledger(s) are combined with the benefits of storage on a secure server or servers (and/or on a user's device or devices) or both.

In one or more embodiments, an unintelligible partial biometric file regardless of its storage location is able to provide sufficient information for nonrepudiation.

In any embodiment, there may be a distributed data storage having some or all of the characteristics of blockchain(s)/distributed ledger(s), such as one or more of immutable storage, encryption, peer-to-peer, decentralization, and/or consensus. In any embodiment, there may be variations of the type of blockchain or distributed ledger, such as a partially decentralized ledger (e.g., a consortium blockchain).

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 shows a system for providing a universal decentralized storage combined with a secure server storage of a user's electronic material, in accordance with one or more implementations;

FIG. 2 shows an exemplary process for securely storing electronic material;

FIG. 2A shows an exemplary process in a schematic flow chart for storage of a biometric image or any image file;

FIG. 3 shows an exemplary process for splitting and storing electronic material, such as a biometric file and/or any other file type;

FIG. 3A shows an exemplary process in a schematic flow chart for storage of any file type, and may be used as part of the processes of FIGS. 2A and 4A;

FIG. 4 shows an exemplary process for splitting and storing electronic material, such as a biometric file;

FIG. 4A shows another exemplary process in a schematic flow chart for storage of a biometric image or any image file;

FIG. 5 shows one method or retrieving and reassembling a securely stored file such as a biometric file;

FIG. 6 shows one method or retrieving and reassembling a securely stored file such as a split biometric file (SPBF);

FIG. 7 shows an exemplary general reassembly process for any file;

FIG. 8 shows an exemplary file deletion process;

FIG. 9 shows an exemplary process for biometric authentication using encrypted SPBF files;

FIG. 10 shows an exemplary process for biometric authentication using hashed SPBF files;

FIG. 11 shows an exemplary process for biometric authentication using an SPBF file and biometric vector;

FIG. 12 shows an exemplary process for biometric authentication using a hashed biometric vector file;

FIG. 13 shows an exemplary process for registration of a user;

FIG. 14 shows an exemplary process for a user to request storage and store electronic material securely;

FIG. 15 shows an exemplary process for a user to request retrieval of securely stored electronic material; and

FIG. 16 shows an exemplary applied blockchain or distributed ledger overview.

### DESCRIPTION OF THE PREFERRED EMBODIMENT(S)

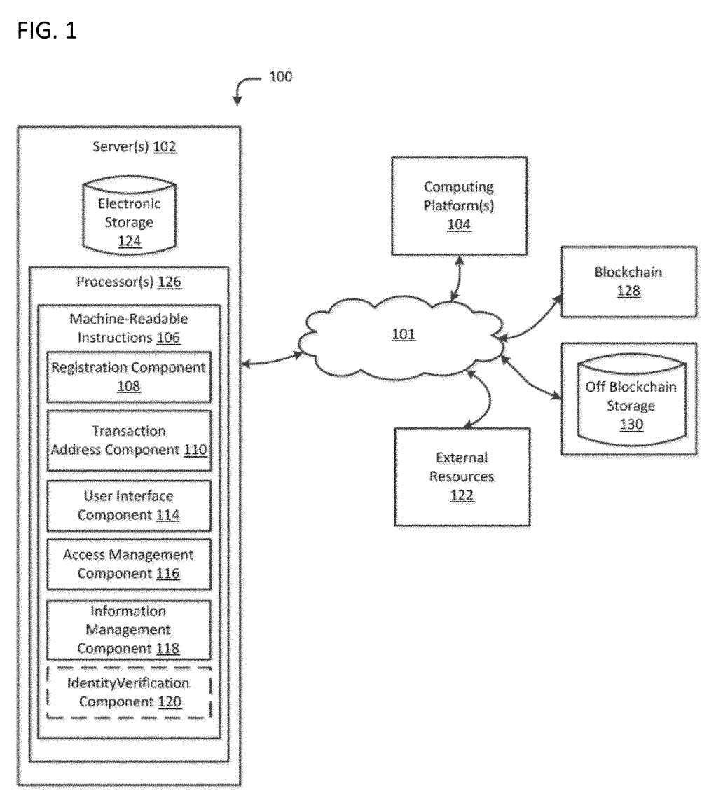

FIG. 1 illustrates a system 100 for providing a universal decentralized solution for secure storage of user's electronic material, in accordance with one or more implementations. In some implementations, system 100 may include one or more servers 102. The server(s) 102 may be configured to communicate with one or more computing platforms 104 according to a client/server architecture, a peer-to-peer architecture, and/or other architectures, e.g., via cloud 101 (e.g., the internet). The users may access system 100 via computing platform(s) 104, which may include an API for such access. The server(s) 102 may be configured to execute machine-readable instructions 106. The machine-readable instructions 106 may include one or more of the following: registration component 108, a transaction address component 110, a user interface component 114, an access management component 116 and an information management component 118. In one or more optional embodiments, there may be an identity verification component 120. There may be, as may be evident to one of ordinary skill in the art, other machine-readable instruction components. Components may be split up and/or combined. The machine-readable instructions 106 may be executable to establish transaction addresses for a blockchain or distributed ledger network. Generally speaking, a blockchain or a distributed ledger is a transaction database shared by some or all nodes participating in system 100. For example, there may be at least one hundred, one thousand, ten thousand, one hundred thousand or one million nodes, or more. Such participation may be based on the Bitcoin protocol, Ethereum protocol, Ripple Consensus Network (Ripple Transaction Protocol or RTXP), Hyperledger by Linux, R3's Corda, Symbiont Distributed Ledger (Assembly), and/or other protocols related to digital currencies, distributed ledgers and/or blockchains. A full copy of the blockchain or distributed ledger contains every transaction ever executed in an associated digital currency or other type of transaction, such as smart contract. In addition to transactions, other information may be contained by the blockchain, such as described further herein.

Where the term “blockchain” is used herein, an alternative embodiment or embodiments would use a “distributed ledger.” Transactions, regardless of type, can be stored in a distributed network or a network data store, including distributed storage, a distributed ledger, blockchain, or other suitable distributed or network-based transaction mechanism. A distributed storage (or “distributed data store”) can include file or file segments stored on one or more networked nodes or stored as a data stream in a network data store. The distributed storage is not limited to a specific format or protocol but can include files of any type stored on any accessible network node, such as servers, desktops, mobile devices, removable storage, or other suitable device. In one embodiment, one file can be stored in its entirety on a single node and another file stored in another network node. Alternatively, a single file can be spilt into a plurality of segments and stored on one or more network nodes. In one embodiment, one file can be stored in its entirety on a single network data store and another file stored in another network data store. Alternatively, a single file can be spilt into a plurality of segments and stored on one or more network data stores. Some transaction networks are designed to be a decentralized payment system, partially decentralized payment system or centralized payment system.

In one embodiment, a distributed ledger can be a database or replicas of a database that are shared and synchronized across a distributed network or networks. Alternatively, a distributed ledger can be a data stream that is flowing in a network data store. The distributed ledger allows transactions to be publicly or privately viewable and replicated, making a cyberattack more difficult. The distributed ledger can also maintain consensus about the existence and status of shared facts in trustless environments (i.e. when the participants hosting the shared database are independent actors that don't trust each other). Consensus may be a requirement of storage of the data. Consensus is not a unique feature of distributed ledger per se: other distributed databases also use consensus algorithms such as Paxos or Raft. Same for immutability: immutable databases exist outside DL (Google HDFS, Zebra, CouchDB, Datomic, etc.).

The distributed ledger can vary from a general distributed database as follows: (a) the control of the read/write access is truly decentralized or partially decentralized, and not logically centralized as for other distributed databases, and as a result; and (b) there is an ability to secure transactions in competing environments, without trusted third parties. Distributed ledgers structures can be linear, such as blockchain, or incorporate Directed Acyclic Graphs (DAG), such as Iota Tangle. Blockchain Iota Tangle, and Hedera hash graph, are specific instances of a distributed ledger, having predefined formats and access protocols.

Blockchain is a distributed ledger that chronologically stores transactions. In a blockchain ledger, all transactions are periodically verified and stored in a “block” that is linked to the preceding block via a cryptographic hash. The blockchain ledger is publicly viewable, allowing the general public to view and keep track of the transactions. Each network node can receive and maintain a copy of the blockchain.

In addition to the above, storage herein may be a network data store, which is referred to data stored in a network, where such data is stored in the network, but not in the nodes of a network.

In some embodiments, storage may be typical digital memory, or it may be in a quantum data storage or quantum storage network (e.g., cloud based). In quantum storage, information is stored as energy in a particle or particles, and transferred e.g., by collisions of particles such as photons. Since the particles transfer their energy as the information is transferred, the information is erased from the carrying particles upon each collision with a new particle.

The registration component 108, which may be configured to register (and help identify) an individual user (an individual or an entity).

As part of the registration component, or its own component, and as explained in more detail in U.S. patent application Ser. No. 15/335,344, filed Oct. 26, 2016 (hereby incorporated by reference herein), the system may receive from an entity, at a blockchain trust utility, information related to one or more verified documents. The one or more verified documents may be associated with such user (e.g., an individual) and may be identification documents, i.e., documents which confirm the identity of the user. The entity may include one or more of an institution, business, company, government body and/or other entities.

The blockchain may be based on several blocks. A block may include a record that contains and confirms one or more waiting transactions. Periodically (depending on the types of transactions and the volume of users in the chain) a new block including transactions and/or other information may be appended to the blockchain. In some implementations, a given block in the blockchain contains a hash of the previous block. This may have the effect of creating a chain of blocks from a genesis block (i.e., the first block in the blockchain) to a current block. The given block may be guaranteed to come chronologically after a previous block because the given block contains the previous block's hash. The given block may be computationally impractical to modify once it is included in the blockchain because of the properties of the hash functions. Moreover, in blockchain, a copy of every transaction is stored on all or at least multiple nodes (e.g., all computers belonging to the particular blockchain universe). Therefore, every corresponding block on all of the nodes in the blockchain network would have to be changed (or at least a majority) as well, otherwise anyone watching the network may discover the inconsistency. Other members of the network of nodes supporting the blockchain can see the contents of the blocks.

The transaction address component 110 may assign a transaction address or addresses to an individual user or users of the system, as explained in more detail below. Such a transaction address may be a necessary requirement in the blockchain to access the information in a particular block associated with the transaction address, in addition to an associated public and private key or other authentication and access control.

The user interface component 114 may provide a user interface.

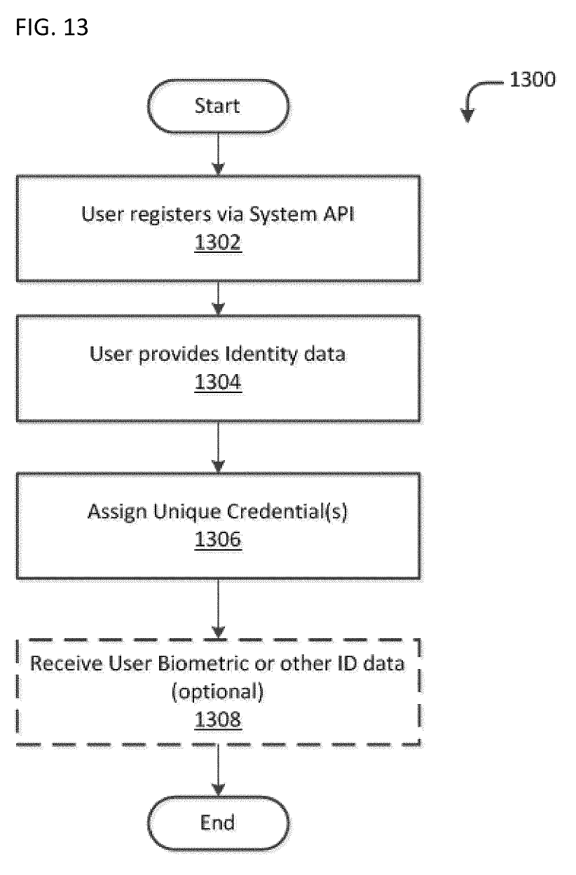

System 100, e.g., via registration component 108, may be configured to register a user. The registration process may be a typical registration process, as shown in FIG. 13. For example, at step 1302 the system may receive a user request via the system API in the user interface component 114 to register. At step 1304, the system may receive the user's identity data, e.g., name, address and email address. The identity data may also include documentary evidence sufficient to verify the user's identity, in a preferred embodiment discussed elsewhere herein. At step 1306, the system may assign the user unique identifier(s) such as a unique credential or credentials, which may be one or more of, e.g., a username, a password or username and password pairing, a number, an alphanumeric code, and/or other credential(s) and/or other information that can be linked to an individual. At step 1308, the system may optionally receive biometric information from the user to provide a relatively high level of security for user authentication.

In accordance with some implementations, an individual having a previously verified personal identity may have obtained the previously verified personal identity through a variety of approaches. For example, in some implementations the individual may be required to provide evidence of the individual's identity. Such evidence (the information referred to above) may include one or more of providing a copy of a government issued identification (e.g., passport and/or driver's license), providing a copy of mail received by the individual (e.g., a utility bill), evidence provided by a third party, and/or other evidence of an individual's identity. The evidence may be provided to an entity associated with server(s) 102.

In some implementations, the information related to the one or more verified documents associated with the user may be encrypted with a first key and a second key. The first key may a server key (e.g., a private key) that is stored on a backend server. The second key may be a client key that is a hash of biometric data associated with the first user. In some implementations, the first and second keys may be applied to the blockchain immutable ID for hyper-encryption of sensitive data formats and/or associated documentation. The identity verification is optional and may occur as part of the registration process.

System 100 may be configured to assign transaction addresses on a blockchain to the registered individuals using the transaction address component 110. A given transaction address may be associated with a public key and a private key (such as is typical in blockchain-based cryptocurrency). By way of example, a first transaction address may be assigned to the individual. The first transaction address may include a first public key and a first private key.

Generally speaking, a public and private key-pair may be used for encryption and decryption according to one or more public key algorithms. By way of non-limiting example, a key pair may be used for digital signatures. Such a key pair may include a private key for signing and a public key for verification of a digital signature. The public key may be widely distributed, while the private key is kept secret (e.g., known only to its proprietor). The keys may be related mathematically but calculating the private key from the public key is unfeasible.

In some implementations, system 100 may be configured such that private keys may be stored within computing platform(s) 104. For example, the first private key may be stored within a computing platform 104 and/or other locations associated with the individual. In accordance with some implementations, a private key may be stored in one or more of a “verify.dat” file, a SIM card, and/or other locations.

In some implementations, system 100 may be configured such that multiple transaction addresses may be assigned to separate individuals. For example, in addition to the first transaction address, a second transaction address may be assigned to a first individual. One or more additional transaction addresses may be assigned to the first individual, in accordance with one or more implementations. A second individual who registers with the system may receive a third transaction address and so on.

System 100 may be configured to record identifiers and biometric data associated with the individuals at corresponding transaction addresses. For example, the first identifier and first biometric data associated with the first individual may be recorded at the first transaction address. Recording information at a given transaction address may include recording a hash or other encrypted representation of the information. In some implementations, different biometric data may be recorded at multiple transaction addresses assigned to a single given individual. For example, in addition to the first identifier and the first biometric data associated with the first individual (first user) being recorded at the first transaction address, the first identifier and second biometric data associated with the first individual may be recorded at a second transaction address.

Generally speaking, biometric data may include metrics related to human characteristics. Biometric identifiers are distinctive, measurable characteristics that can be used to label and describe individuals. Biometric identifiers typically include physiological characteristics but may also include behavioral characteristics and/or other characteristics. Physiological characteristics may be related to the shape of an individual's body. Examples of physiological characteristics used as biometric data may include one or more of fingerprint, palm veins, face recognition, genomic information, DNA sequence(s) and DNA modification(s), proteomic information, and protein sequence(s) and protein modification(s), palm print, hand geometry, iris recognition, retina, odor or scent, and/or other physiological characteristics. Behavioral characteristics may be related to a pattern of behavior of an individual. Examples of behavioral characteristics used as biometric data may include one or more of typing rhythm, gait, voice, heartrate, and/or other behavioral characteristics.

The biometric data may include one or more of an image or other visual representation of a physiological characteristic, a recording of a behavioral characteristic, a template of a physiological characteristic and/or behavioral characteristic, and/or other biometric data. A template may include a synthesis of relevant features extracted from the source. A template may include one or more of a vector describing features of a physiological characteristic and/or behavioral characteristic, a numerical representation of a physiological characteristic and/or behavioral characteristic, an image with particular properties, and/or other information.

Biometric data may be received via computing platforms 104 associated with the individuals. For example, biometric data associated with a first individual may be received via a first computing platform 104 associated with the first individual. The first computing platform 104 may include an input device (not depicted) configured to capture and/or record a physiological characteristic and/or behavioral characteristic of the first individual. Examples of such an input device may include one or more of a camera and/or other imaging device, a fingerprint scanner, a microphone, an accelerometer, and/or other input devices.

System 100 may be configured to provide an interface for presentation to individuals via associated computing platforms 104. The interface may include a graphical user interface via user interface component 114 presented via individual computing platforms 104. According to some implementations, the interface may be configured to allow a given individual to add or delete storage addresses assigned to the given individual so long as at least one storage address is assigned to the given individual.

In some implementations, system 100 may be configured to access and/or manage one or more user profiles and/or user information associated with users of system 100. The one or more user profiles and/or user information may include information stored by server(s) 102, one or more of the computing platform(s) 104, and/or other storage locations. The user profiles may include, for example, information identifying users (e.g., a username or handle, a number, an identifier, and/or other identifying information), security login information (e.g., a login code or password), system account information, subscription information, digital currency account information (e.g., related to currency held in credit for a user), relationship information (e.g., information related to relationships between users in system 100), system usage information, demographic information associated with users, interaction history among users in system 100, information stated by users, purchase information of users, browsing history of users, a computing platform identification associated with a user, a phone number associated with a user, and/or other information related to users.

The machine-readable instructions 106 may be executable to perform blockchain-based and secure server or servers-based storage of electronic material in conjunction with one or more individual identifiers and transaction address(es).

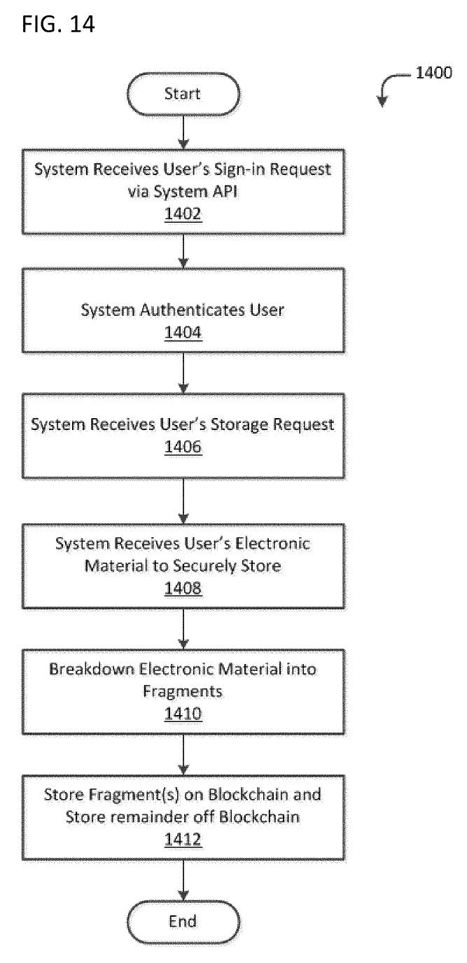

In FIG. 14, there is shown a process for a user to request storage and store electronic material securely. This electronic material generally would be in file format or in some discrete format. At step 1402, the system may receive the user's sign-in request via the API. At step 1404, the system may authenticate the user, e.g., using the user's stored biometric information, and other identifier(s) recorded during the registration process. At step 1406, the system may receive the user's storage request. At step 1408, the system may receive the user's electronic material for storage. At step 1410, the system may breakdown the electronic material into file fragments, each fragment preferably being a part of the file but which is unintelligible alone and collectively, unless all fragments of the file are fully assembled into the intelligible (by machine or human) file. In one or more embodiments, for example, one fragment may be a file header, and another fragment or fragments may be data or image data from the file. The file header itself may be split into more than one fragment. At step 1412, the system may store one or more file fragments on a blockchain or blockchains in one or more blocks thereon (e.g., preferably as transactions), on a distributed ledger or distributed ledgers at one or more locations thereon (e.g. preferably as transactions) or in a distributed database at one or more locations thereon, and store the remaining file fragment or file fragments off of the blockchain, off of the distributed ledger or outside of a distributed database, e.g., in a secure server or servers, and/or on a user device or devices. A fragment or fragments may be stored online or off line, e.g., in other digital storage device or devices which device may be removable from online, and usually does not have its own CPU, such as a USB, SIM card, thumb drive, or other suitable device.

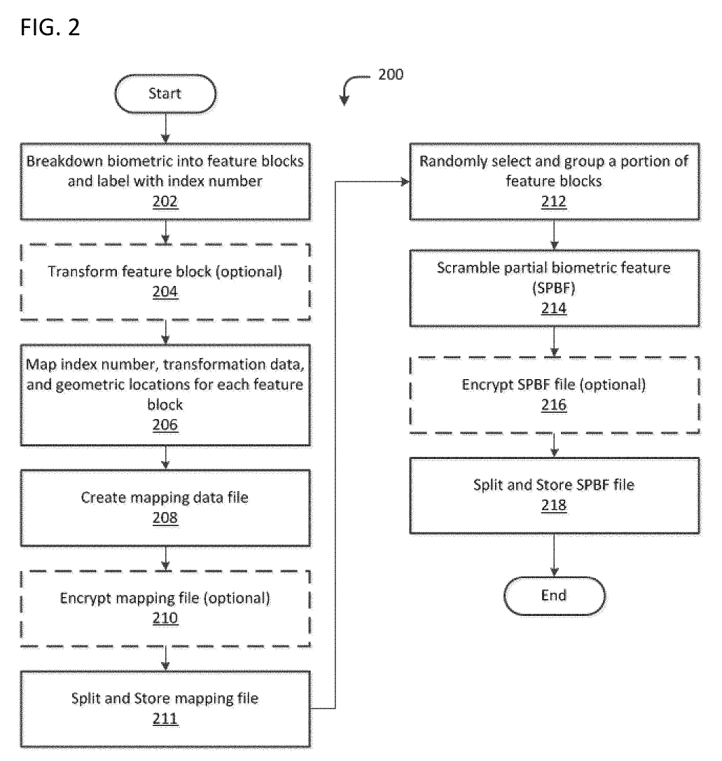

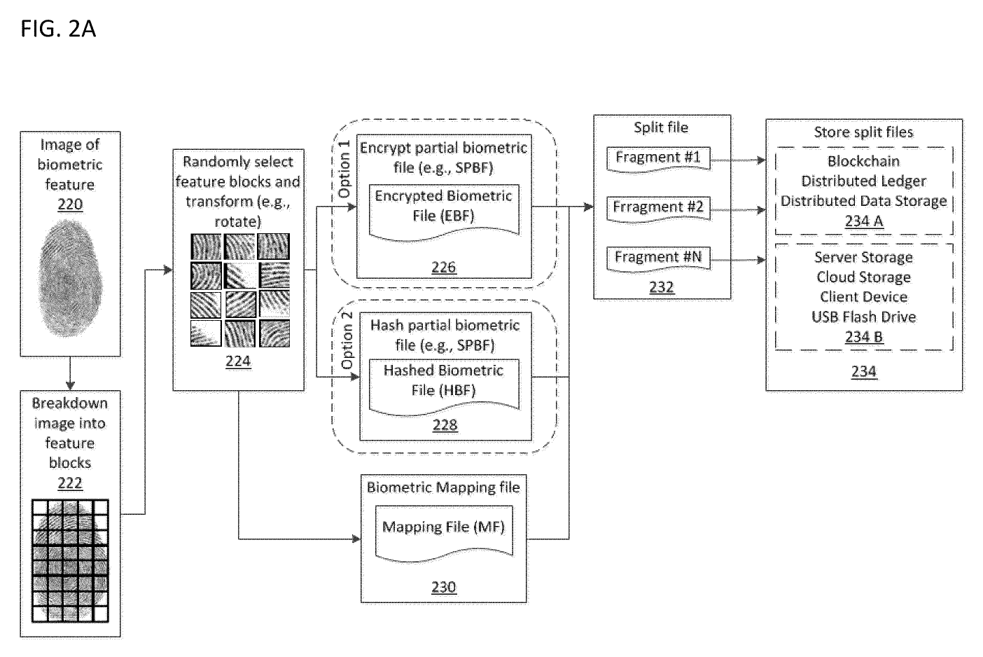

For example, FIG. 2 shows an exemplary system 100 which may perform the following steps to securely store electronic material such as a biometric and/or other highly personal and/or confidential information. The system may enter this secure storage component during user registration into the secure storage system, e.g., to store a user's biometric electronic material to be used as part of an authentication requirement, and/or this storage may occur when the user wants to use the system to securely store electronic material such as the user's biometric electronic material in response to a post registration request for secure storage of electronic information by a user.

In step 202, the system may, during registration or after registering a user and assigning a user identification and authentication (preferably dual authentication or greater), breakdown the biometric electronic information into multiple feature blocks, and label each feature block with an index number. The index number can be randomized as an optional aspect of the indexing process, such as with a pseudorandom number generator, or other suitable randomizer.

At step 204, which is optional, the system can optionally transform one or more of the feature blocks by rotating, flipping, masking and/or other method, preferably randomly but it could be pseudorandom or in a predetermined manner. Where the biometric information is voice and the feature blocks are voice blocks, each block can optionally be reversed, masked, pitch transformed, and/or other method of manipulation. The system records the transformation data (e.g., the flip/rotation information). It should be noted that transformations need not necessarily occur, and not necessarily at this stage, and could be done earlier or later in the process, in any embodiment herein.

At step 206, the system may map the index number, transformation data, and geometric locations of each data block.

At step 208, the system creates a mapping file with the index number, transformation data, and geometric locations gathered in the previous step.

At step 210, which is optional, the system encrypts the mapping file.

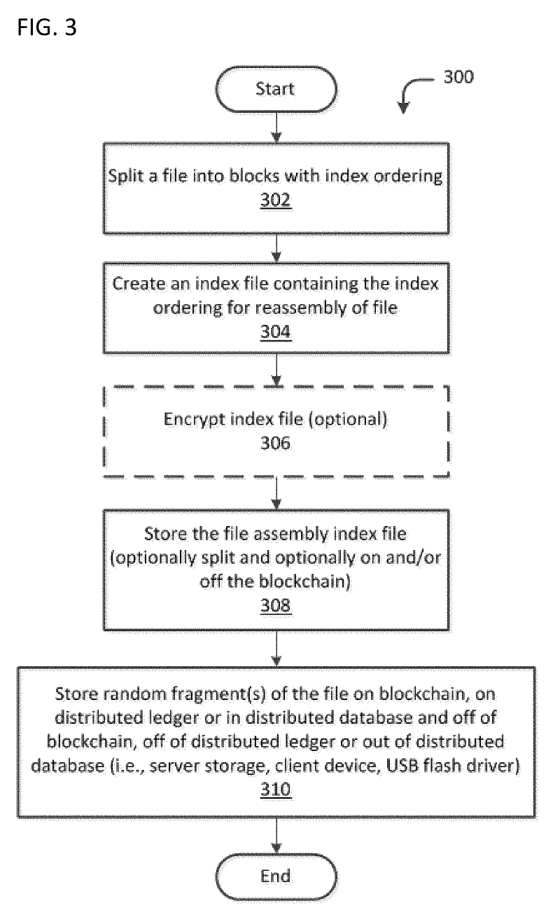

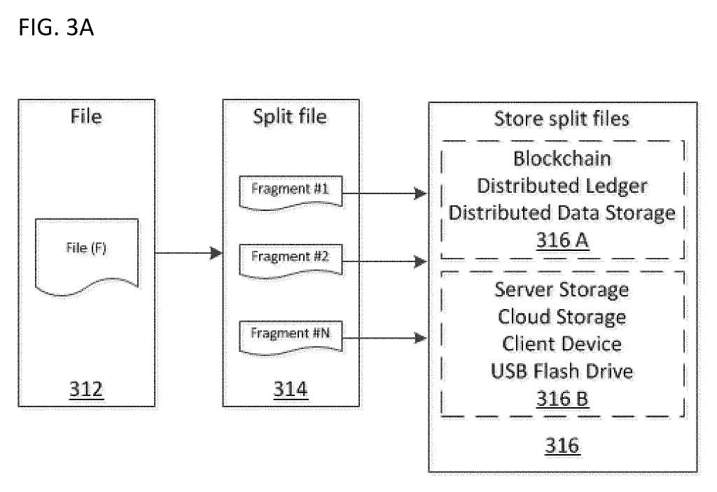

At step 211, the system splits (optionally) and stores the mapping file too. Details describing one embodiment of how the system may split and store the mapping file are shown in process 300 in FIG. 3.

At step 212, the system may select a portion of the feature blocks and group them together (e.g., a percentage such as 30% of the feature blocks), preferably randomly but it could be pseudorandom or in a predetermined manner. This step may be done multiple times along with steps 214, 216 and 300 to create multiple split biometric files. In the process of selecting a portion of the feature blocks for grouping, a given feature block can be selected more than once.

At step 214, the system may take a grouping of the feature blocks and assemble the feature blocks to form a scrambled partial biometric feature (SPBF) by creating a new file. This step may be done multiple times to create multiple SPBFs, according to one or more approaches discussed below.

At step 216, which is optional, the system may encrypt the SPBF file. The encryption of the SPBF file can be achieved via an AES algorithm, a PGP algorithm, Blowfish algorithm, or other suitable encryption algorithm.

At step 218, the system can again proceed to process 300 to split and store the SPBF file.

With respect to storing biometric files, it should be noted that multiple approaches may be used for splitting the file and storing it. For example, one approach may be splitting an original biometric feature file or an SPBF file (either encrypted or not) into more than one fragment and creating files for each fragment for storage in one or more storage devices. This approach can also be applied to storage of an index file, mapping file, geometric location file, and/or other files necessary to reconstruct the original electronic material.

All of a split file (i.e., all of the “fragment” files formed by splitting up or breaking down a file) should be stored in order to reconstruct the original file. There should be an additional file or files for storage of the information on how the file has been split up, i.e., an index file containing the order (index ordering) of the file fragments for assembly. The index file is needed for later reconstruction of the original file. This approach can also be applied to a hashed file of an original biometric feature file. In such case, SPBF files need not be and preferably are not generated. In one embodiment, the index file itself is optionally split, just like the original file, and preferably stored partly on the blockchain, on the distributed ledger, or in the distributed database and partly off of the blockchain, off of the distributed ledger, or outside of the distributed database. There will then be an index file for the (primary) index file. This “secondary” index file should be stored in the most secure way, possibly off line, and encrypted, preferably by a different encryption method than the primary index file.

Another approach to handling breakdown and storage of biometric files is selection of different feature blocks to form different SPBF files (either encrypted or not), and storing such different SPBF files in one or more storage devices. The feature blocks of the SPBF files can cover all or a portion (e.g., in the case of use for authentication) of the original biometric feature data file. In this approach, for a single biometric feature, one or more SPBF files in any combination can be used for one or more biometric authentications.

For a single biometric feature, SPBF files (in case more than one are generated) and the corresponding fragment files can be separately stored at different locations on one blockchain under one or more transaction addresses, and/or under one or more smart contract addresses and/or under one or more blockchain utility addresses. For a single biometric feature, SPBF files (in case, more than one are generated) and fragment files can be separately stored on one or more independent blockchains and/or in one or more transaction records on one or each blockchain, on one or more independent distributed ledgers and/or in one or more transaction records on one or each distributed ledger, or in one or more independent distributed database and/or in one or more records in one of each distributed database. For a single biometric feature, one or more SPBF files or fragment files can be encrypted before storage. For one or more encrypted SPBF files and/or fragment files resulting from a single biometric feature, only the owner of the biometric feature has the passphrase/key to decrypt those files, especially when those files are stored in a blockchain, a distributed ledger or a distributed database (either public or private). This helps to ensure that no one other than the owner of the biometric feature can use those encrypted files for biometric authentication. The SPBF files can be hashed before storage.

Each of the above approaches for breakdown and storage of biometric files may be used alone or in combination.

FIG. 2A shows an exemplary process in a schematic flow chart for storage of a biometric image. At step 220, the system can receive an image of a biometric feature (such as to start in FIG. 2). At step 222 (as in step 202), the system can breakdown the image into blocks (feature blocks). At step 224 (as in steps 204, 208, 212 and 214), the system can select (e.g. randomly for more security but such selection could be pseudorandom or according to a nonrandom selection method) some feature blocks to join or group together. In that process, the system can transform the feature blocks, e.g., by rotation such as rotating a predetermined amount such as ninety degrees or a random amount. At step 230, the system creates the mapping file (as in steps 206, 208, 210). The mapping file or files then can, at steps 232 and 234, be split (optionally) and the file fragments stored partially on the blockchain, on the distributed ledger or in the distributed database (referred to as storage options in 234A) and partially on off blockchain storage, off distributed ledger storage, or off distributed data storage such as in the cloud server or servers, a secure server, or servers (e.g., owned by an entity or person) and/or on a client device or devices, e.g., a user's mobile phone, tablet, laptop and/or desktop computer or other user device (as in steps 211 and 218 of FIG. 2 and process 300 of FIG. 3 and referred to as storage options in 234B). Storage options 234B may include network data store.

A fragment or fragments may be stored in other digital storage device or devices which device and usually do not have its own CPU, such as a SIM card, USB thumb drive, or other suitable device. Meanwhile, at step 226 (as in step 216) or step 228 (not shown in process 200 but could be optionally used there in place of step 216), the system may, selectively and optionally, apply encryption or hashing, respectively, to the partial biometric file, SPBF file or files formed at step 224. In one embodiment, the hashing of the partial biometric/SPBF file can be achieved by application of an MD5 algorithm, SHA algorithm (e.g., SHA-0), SHA-2 algorithm (e.g., SHA-256), or other suitable hashing algorithm. In another embodiment, the encryption of the partial biometric/SPBF file can be achieved by application of an AES algorithm, a PGP algorithm, Blowfish algorithm, or other suitable encryption algorithm. It should be noted that as in the case of the index file, the mapping file itself is optionally split, just like the original file, and preferably stored partly (or fully) on the blockchain and partly off of the blockchain, partly (or fully) on the distributed ledger and partly off of the distributed ledger, or partly (or fully) in the distributed database and partly outside of the distributed database. There will then be a mapping or index file for the (primary) mapping file. This “secondary” mapping or index file should be stored in the most secure way, possibly off line, and encrypted, preferably by a different encryption method than the primary mapping file. Preferably, in any embodiment herein, storage of the mapping file or at least part of the mapping file would be in the blockchain or distributed ledger.

FIG. 3 shows an exemplary version of routine 300 e.g., as used in other figures, which may perform the following steps to split and store electronic material, such a biometric file and/or any other file type.

At step 302, the system may split the electronic material into fragments (two or more), each fragment being a file (a “fragment file”), such fragment file representing a block or blocks, or slice or slices, or other piece or pieces of the electronic material to be stored. The system may also index the order (“index ordering”) of the fragment files. For a biometric file, the system may split the file into fragments such as feature blocks with index ordering. A fragment file formed from the electronic material may include part of the data and/or image and/or sound and/or video of an electronic file or other electronic material. In some embodiments, the fragment file may be or may include a file header or a portion of a file header. As part of this step, the system may also store the file fragments, as explained above, one or more on the blockchain and one or more off of the blockchain, one or more on the distributed ledger and one or more off of the distributed ledger, or one or more in the distributed database and one or more outside of the distributed database (see step 310 below).

At step 304, the system may create an index file for reassembly of the original file.

At step 306, the system may optionally encrypt the index file.

At step 308, the system may store the index file (for later file assembly). The system may store the index file on the blockchain or off of the blockchain storage, and may use a hash table for location data, preferably distributed to all of the nodes on the blockchain, e.g., while storing the index file off of the blockchain. The index file itself, as in other embodiments explained herein, may be split and stored, preferably part on the blockchain and part off of the blockchain, part on the distributed ledger and part off of the distributed ledger, or part in the distributed database and part outside of the distributed database.

At step 310, the system may store any selection, most preferably a random selection (or it could be pseudorandom or a predetermined method), of a fragment or group of the fragments of the electronic material being securely stored on off blockchain storage, distributed ledger storage or distributed data storage, which may be a secure server or servers, e.g., owned by an entity or person, and/or a client device, e.g., a user's mobile phone, tablet, laptop and/or desktop computer or other user device. A fragment or fragments may be stored in other digital storage device or devices which device and usually do not have its own CPU, such as a SIM Card, USB thumb drive, or other suitable device. As in all embodiments herein, the timing of when a step occurs in relation to other steps may be varied, where possible.

The system may store at least one fragment of the electronic material on the blockchain, on the distributed ledger or in the distributed database. This fragment or fragments should be necessary to reconstruct the file (electronic material) into an intelligible file (i.e., having at least some understandable material), intelligible to a machine and/or to a human. For example, as in any embodiment herein, this at least one fragment may be the header portion of a file being securely stored, or a portion of the header, and may or may not include a portion of the rest of the file. This at least one fragment is also preferably the smallest size from a data storage perspective (smallest byte size) as reasonably possible to achieve the goal of the electronic material being meaningless without this fragment, so as to minimize the storage and retrieval load on the blockchain system. The system may optionally store multiple fragments in separate storage on the blockchain, on the distributed ledger or in the distributed database. This storage step is shown diagrammatically in FIG. 3A, discussed below.

In all embodiments herein disclosed, the system, in storing a fragment or fragments on the blockchain, may store such fragments in multiple blocks (e.g., as transactions) on the blockchain; the system, in storing a fragment or fragments on the distributed ledger, may store such fragments at multiple locations (e.g., as transactions) on the distributed ledger; or the system, in storing a fragment or fragments in the distributed database, may store such fragments at multiple locations in the distributed database. The system, blockchain, distributed ledger and/or distributed database may also be adapted to further breakdown the fragment or fragments being stored and distribute such fragments across the blockchain nodes, distributed ledger nodes, distributed data storage nodes, as a data stream in a network data store. Preferably, access to a blockchain node, a distributed ledger node, a distributed data storage node or a network data store to use a file fragment for reassembly would require authentication and use of the private key as well as the transaction address or smart contract address. For enhanced security, transaction addresses or smart contract addresses may be updated periodically based on time, and/or after each use.

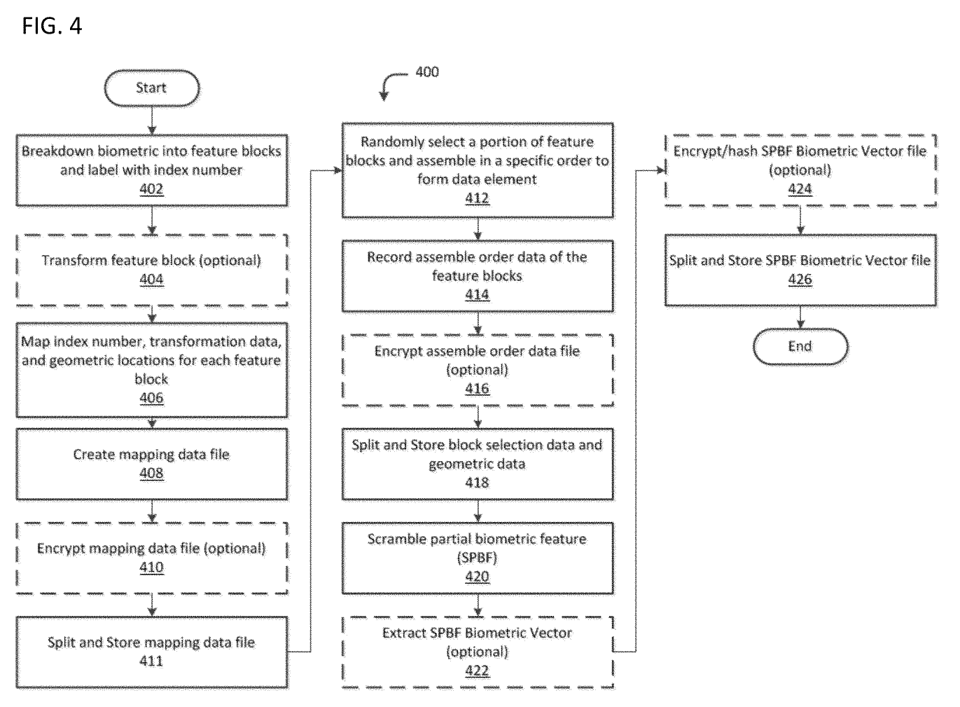

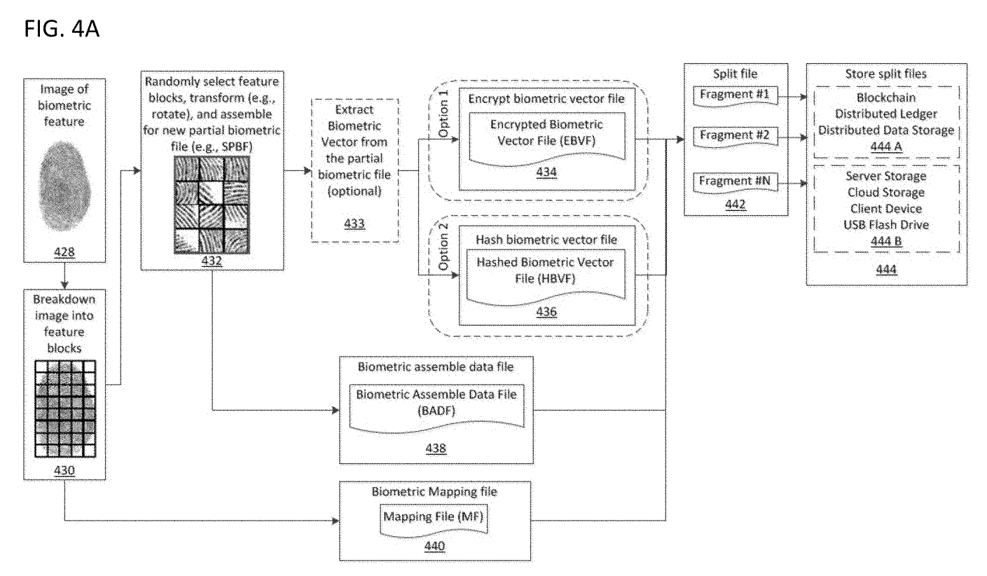

FIG. 3A shows an exemplary process in a schematic flow chart for storage of any file type, and may be used as part of the processes of FIGS. 2A and 4A. It may be considered an expansion of step 310 of FIG. 3.

At step 312, the system can receive a file to split and store. In step 314, the system may split the file into fragments. In step 316, the system may store at least one fragment or fragments on the blockchain, distributed ledger or distributed database and the remaining fragment or fragments on or off blockchain storage, off distributed ledger storage or off distributed data storage (grouped together in box 316A), which may be a cloud server or servers, a secure server or servers, e.g., owned by an entity or person, and/or a client device or devices, e.g., a user's mobile phone, tablet, laptop and/or desktop computer or other user device (grouped together in box 316B). A fragment or fragments may be stored in other digital storage device or devices which device and usually do not have its own CPU, such as a SIM card, USB thumb drive, or other suitable device.

FIG. 4 is an exemplary version of routine 400 e.g., which may be used in other figures in place of routine 300, split and store electronic material, such as a biometric file.

In step 402, the system may breakdown a biometric into feature blocks and label each feature block of a biometric file with an index number, the same or similar to as in step 202 above. This index number can be randomized as an optional piece of the indexing process but as in any embodiment herein, it may be pseudo-randomly selected or selected by a predetermined method.

In step 404, which is optional, the system may transform a feature block the same or similar to as in step 204 above. The system records the transformation data (e.g., the flip/rotation information).

In step 406, the system maps the index number, transformation data, and geometric locations of each feature block the same as or similar to as in step 206 above.

In step 408, the system creates a mapping file (or mapping data file) with the index number, transformation data, and geometric locations gathered in the previous step 406.

In step 410, which is optional, the system encrypts the mapping data file. The encryption of the mapping file can be achieved via an AES algorithm, a PGP algorithm, Blowfish algorithm, or other suitable encryption algorithm.

In step 411, the system splits (optionally) and stores the mapping file as explained above, using the process 300 shown in detail in FIG. 3. As in the other embodiments herein, the primary mapping and/or index file may be itself split using the same process as splitting and storing the original file, and for enhanced security, stored partly online (such as blockchain and off blockchain) and/or partly off line.

In step 412, the system randomly selects a portion of the feature blocks (e.g., thirty percent of the feature blocks) and assembles them according to a random order (or it could be pseudorandom or a predetermined order) in a two-dimensional or multidimensional manner.

This step may be done multiple times along with steps 414, 416, 418, 300, 420, 422, 424, 300 to create multiple SPBF, block selection, and geometric data files.

Specifically, in step 414, the system may record the assemble order data for the feature blocks into an assemble order data file.

In step 416, the system may encrypt the assemble order data file. The encryption of the assemble order data file can be achieved via an AES algorithm, a PGP algorithm, Blowfish algorithm, or other suitable encryption algorithm.

In step 418, the system may split and store block selection data and geometric data files, such as by using process 300.

In step 420, the system may assemble the feature blocks to form the scrambled partial biometric feature (SPBF) by creating a new file.

In step 422, which is optional, the system may extract an SPBF biometric vector.

In step 424, which is optional, the system may encrypt/hash the SPBF file or the SPBF biometric vector file.

In step 426, as shown in process 300 above, the system may split and store the SPBF (SPBF vector) file using the outlined process steps in process 300.

FIG. 4A shows another exemplary process in a schematic flow chart for storage of a biometric image. At step 428, the system can receive an image of a biometric feature (such as to start in FIG. 4). At step 430 (as in step 402 of FIG. 4), the system can breakdown the image into blocks (feature blocks). At step 432 (as in step 404 and steps 406, 412, 420 and 422), the system can select (e.g. randomly for more security but such selection could be pseudorandom or according to a nonrandom selection method) some feature blocks for assembly. In this process, the system can transform the feature blocks (e.g., by rotation such as rotating a predetermined amount such as ninety degrees or a random amount). At step 438, the system creates the biometric block selection and assemble order data file (as in steps 414 and 416 in FIG. 4). The biometric block selection and assemble order data file or files then may, at steps 442 and 444, be split and the file fragments stored partially on the blockchain, on the distributed ledger or in the distributed database and partially on or off blockchain storage, off distributed ledger storage or off distributed data storage such as in the cloud server or servers, a secure server or servers, and/or on a client device or devices, a user's mobile phone, tablet, laptop and/or desktop computer or other user device. Box 444A shows storage options on the blockchain, distributed ledger or in the distributed database, and box 444B shows storage options off of the blockchain, off of the distributed ledger and/or outside of the distributed database. A fragment or fragments may be stored in other digital storage device or devices which device and usually do not have its own CPU, such as a SIM card, USB thumb drive, or other suitable device. Meanwhile, at step 433 (optional), the system can extract a biometric vector from the partial biometric file. Then, at step 434 (as in step 424 in FIG. 4) or step 436 (as in step 424 in FIG. 4), the system may, selectively and optionally, apply encryption or hashing, respectively, to the SPBF file, SPBF biometric vector file or files formed at step 432. At step 440, the system may create a biometric mapping file (and optionally encrypt it) (as in steps 408 and 410 in FIG. 4). At step 442, the system may split the mapping file or files into fragments (as in steps 411, 418, 426 of FIG. 4 and process 300 of FIG. 3). At step 444, the system may store the file fragments partially on the blockchain, on the distributed ledger or in the distributed database and partially on off blockchain storage, off distributed ledger storage or off distributed data storage such as in the cloud server or servers, a secure server or servers, and/or on a client device or devices (as in steps 411, 418, 426 in FIG. 4 and process 300 of FIG. 3). A fragment or fragments may be stored in other digital storage device or devices which device and usually do not have its own CPU, such as a SIM card, USB thumb drive, or other suitable device.

After secure storage of a biometric file has occurred, a user may wish to access the biometric or the system may need to access the biometric or SPBF file to compare to a user's biometric or SPBF to authenticate the user.

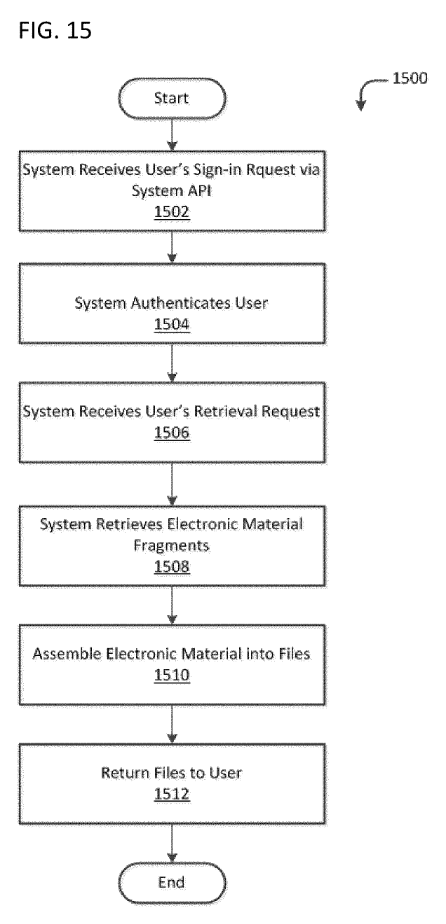

In FIG. 15, there is shown a process for a user to request retrieval of securely stored electronic material. At step 1502, the system may receive the user's sign-in request via the API. At step 1504, the system may authenticate the user, e.g., using the user's stored biometric information, and other identifier(s) recorded during the registration process. At step 1506, the system may receive the user's retrieval request. At step 1508, the system may retrieve the user's fragments of electronic material from storage. At step 1510, the system may assemble the file fragments into one or more files. At step 1512, the system may return the file(s) to the user, e.g., by display or read-only, by being downloadable, and/or by other means.

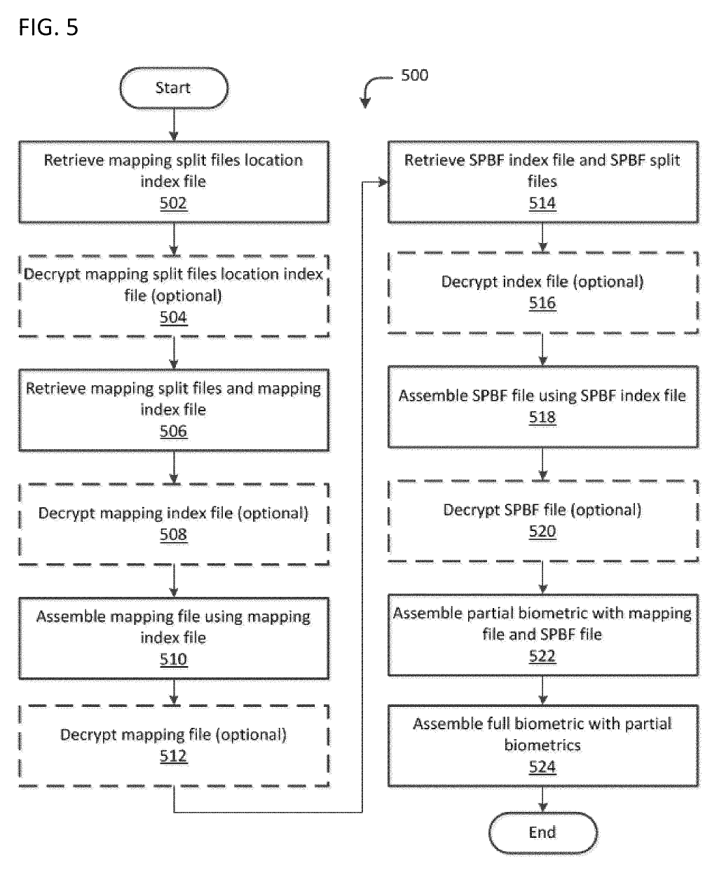

FIG. 5 shows one method or retrieving and reassembling a securely stored file such as a biometric file. In step 502, the system may retrieve the mapping file and location index file.

In step 504, the system may decrypt the mapping file location index file.

In step 506, the system may retrieve mapping split files and mapping index file using mapping file location index file.

In step 508, which is optional, the system may decrypt the mapping index file.

In step 510, the system may assemble mapping file using mapping index file and mapping split files.

In step 512, which is optional, the system may decrypt the mapping file.

In step 514, the system may retrieve the SPBF index file and SPBF split files.

In step 516, which is optional, the system may decrypt the SPBF index file.

In step 518, the system may assemble the SPBF file using the SPBF index file and the SPBF split files.

In step 520, which is optional, the system may decrypt the SPBF file.

In step 522, the system may assemble a partial biometric using the mapping file and the SPBF file.

In step 524, the system may assemble a full biometric using two or more partial biometrics.

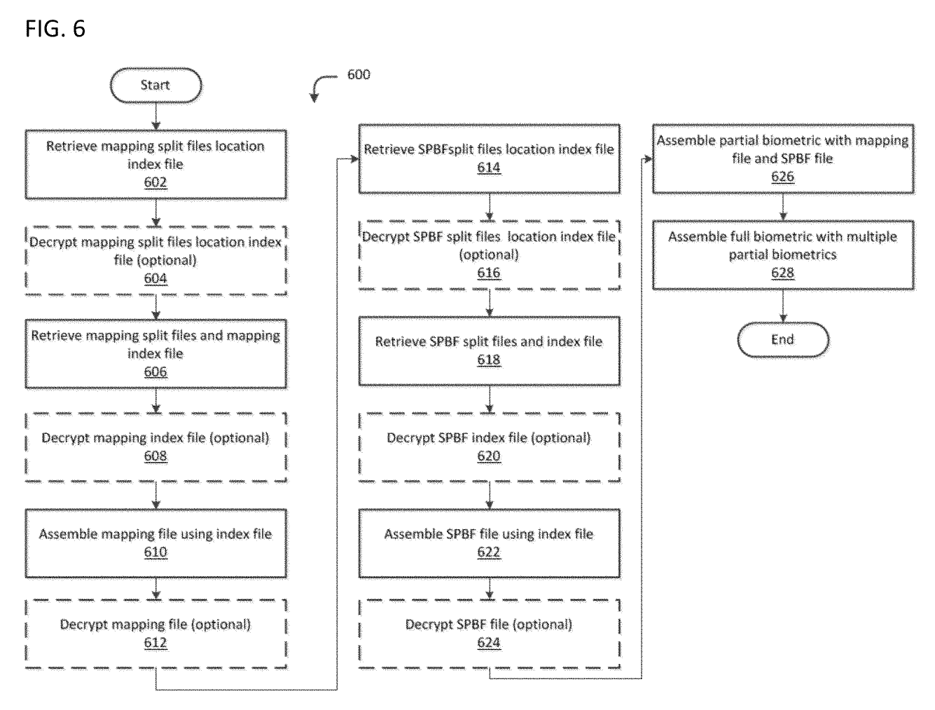

Alternatively, reassembly of the SPBF may use the process of FIG. 6.

In step 602, the system may retrieve mapping file location index file.

In step 604, which is optional, the system may decrypt mapping file location index file.

In step 606, the system may retrieve the mapping split files and mapping index file using mapping file location index file.

In step 608, which is optional, the system may decrypt the mapping index file.

In step 610, the system may assemble the mapping file using the mapping index file and mapping split files.

In step 612, which is optional, the system may decrypt the mapping file.

In step 614, the system may retrieve the SPBF split files location index file.

In step 616, which is optional, the system may decrypt the SPBF split files location index file.

In step 618, the system may retrieve the SPBF index file and the SPBF split files using the SPBF split files location index file.

In step 620, which is optional, the system may decrypt the SPBF index file.

In step 622, the system may assemble the SPBF file using the SPBF index file and the SPBF split files.

In step 624, which is optional, the system may decrypt the SPBF file.

In step 626, the system may assemble the partial biometric using the mapping file and the SPBF file. The biometric mapping file should contain sufficient information for biometric reassembly.

In step 628, the system may assemble a full biometric using two or more partial biometrics.

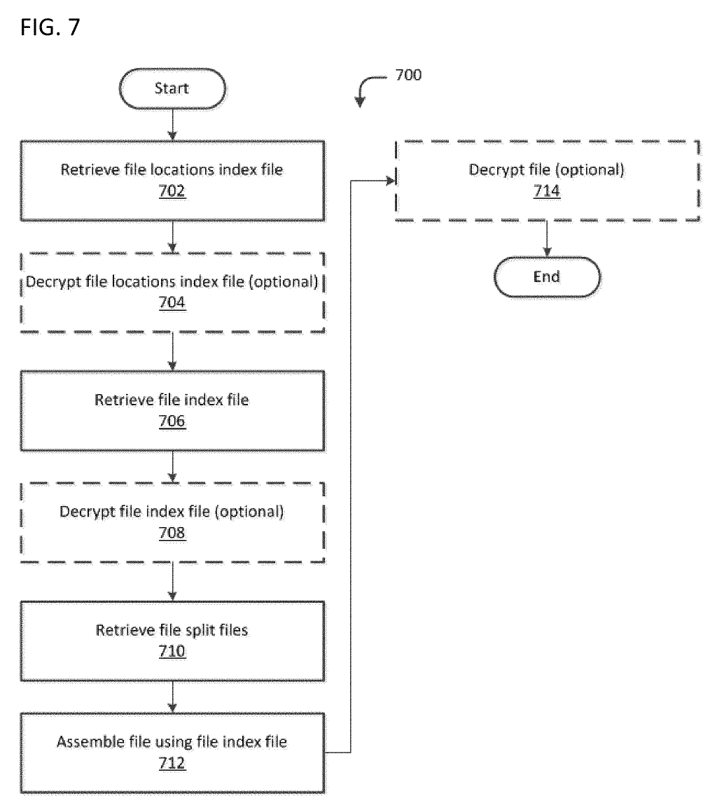

FIG. 7 shows an exemplary general reassembly process for any file.

In step 702, the system may retrieve the file locations index file. In step 704, which is optional, the system may decrypt the file locations index file. In step 706, the system may retrieve the file index file. In step 708, which is optional, the system may decrypt the file index file. In step 710, the system may retrieve the file split files. In step 712, the system may assemble file using file split files and index file. In step 714, which is optional, the system may decrypt the file.

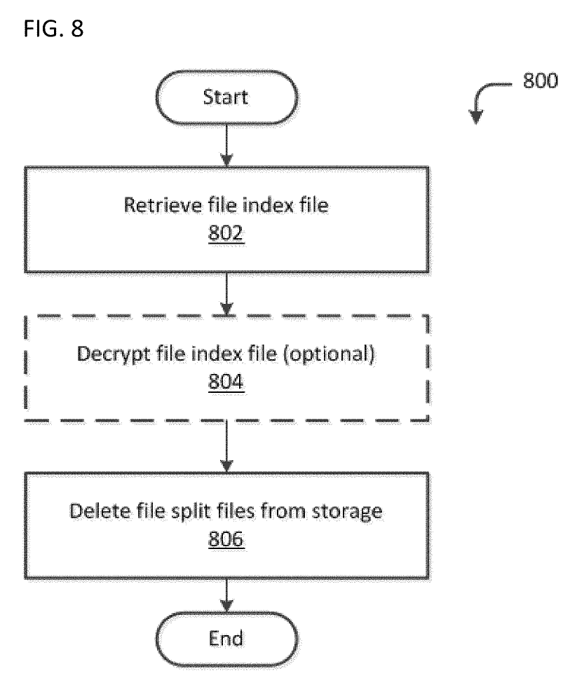

FIG. 8 shows an exemplary file deletion process. In step 802, the system may retrieve the file index file. In step 804, which is optional, the system may decrypt the file index file. In step 806, the system may delete a fragment file or files using the file index file locations where applicable (e.g., from off blockchain, cloud storage, company server, or client device).

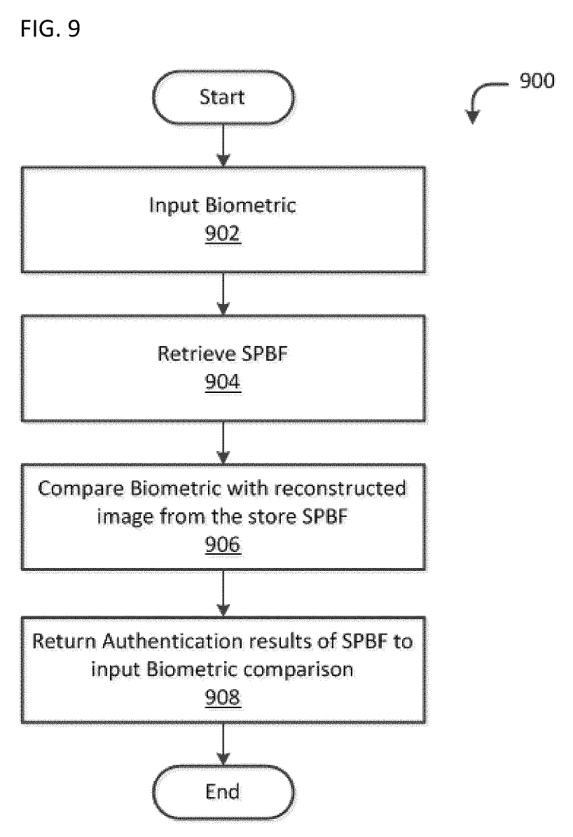

FIG. 9 shows an exemplary process for biometric authentication using encrypted SPBF files. This biometric authentication may be used to identify the user so that the user can access or grant access to the securely stored file(s). It should be noted that when an SPBF file is subsequently used to reconstruct a full or partial portion of an original biometric file, such SPBF file preferably should not be hashed before storage, because hashing is irreversible and so reconstruction will not be likely. Extraction of a biometric vector from an SPBF (which is not encrypted and not hashed) is optional. When a biometric vector is used, hashing (optional) preferably should only be done on a non-encrypted and non-hashed biometric vector file, but not on an SPBF file. This is because generally a useful biometric vector can only be extracted from a non-encrypted and non-hashed SPBF file or files or from the non-encrypted and non-hashed original biometric file or files.

Referring to FIG. 9, at step 902, the system may receive a biometric capture of person (the user) looking to be verified using biometric apparatus. At step 904, the system may retrieve an SPBF using one of the identified processes 500 of FIG. 5 or 600 of FIG. 6. At step 906, the system may apply comparison of images or patterns recreated from the stored SPBF and input biometric. At step 908, the system may return positive or negative results based upon comparison results.

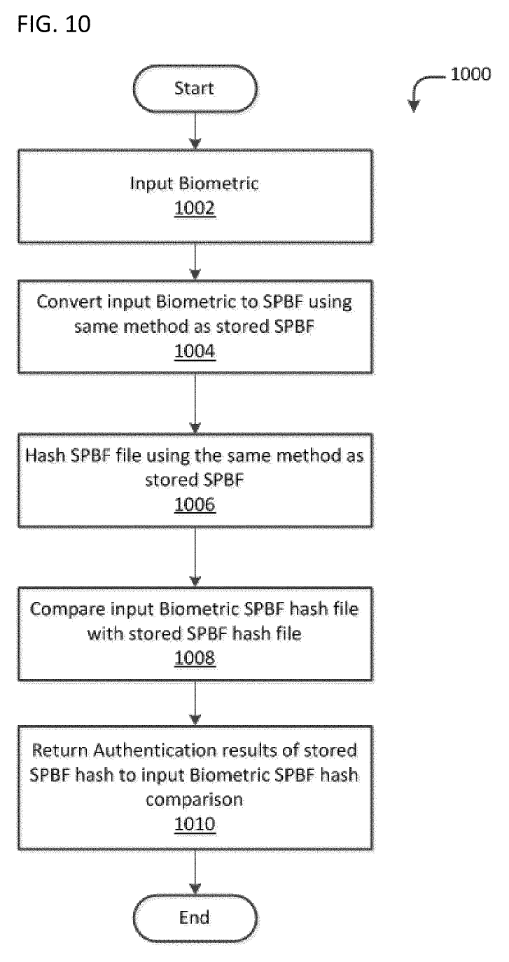

FIG. 10 shows an exemplary process for biometric authentication using hashed SPBF files (e.g., in response to a user request for authentication and/or access). At step 1002, the system may receive an input biometric, e.g., from the user using a biometric capturing device and transmitting the captured biometric information to the system.

At step 1004, the system can convert the inputted biometric to an SPBF file using the conversion method as when the user's SPBF file was stored (e.g., as in FIG. 2, 4 or 4A). That is, the system can retrieve mapping data, transformation data, assemble order, and index files used during creation of the original SPBF file and select the same feature blocks and perform any transformations and assembly that were performed during the original storage.

At step 1006, the system can hash the SPBF file using the same hashing routine as when the user's SPBF file was hashed during storage (e.g., as in FIG. 2, 4 or 4A).

At step 1008, the system can compare the SPBF hash file with the stored SPBF hash file.

At step 1010, the system can return the results of the comparison, i.e., a match or no match and use that result for the biometric portion of an authentication routine.

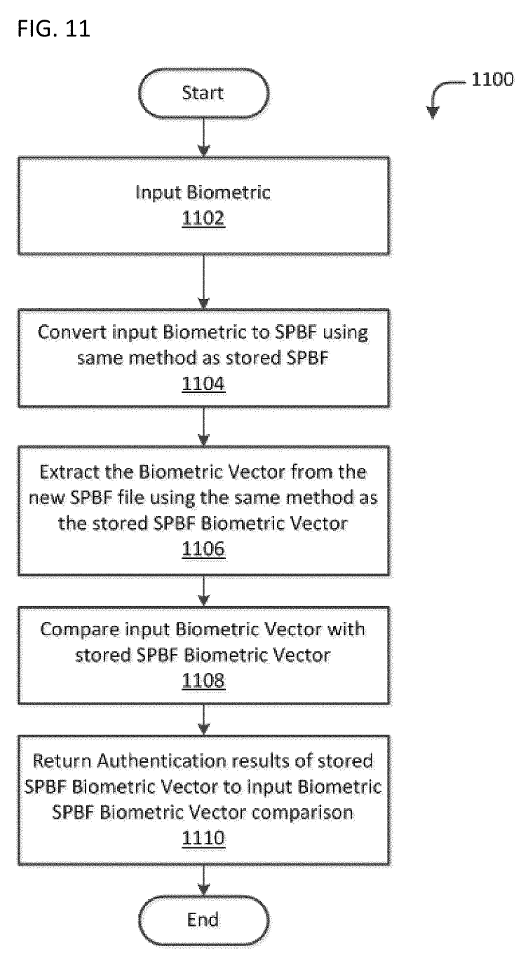

FIG. 11 shows an exemplary process for biometric authentication using an SPBF biometric vector. At step 1102, the system can receive an input biometric, e.g., from the user using a biometric capturing device and transmitting the captured biometric information to the system.

At step 1104, the system can convert the inputted biometric to an SPBF file using the conversion method as when the user's SPBF file was stored (e.g. FIG. 4 or 4A). That is, the system may retrieve the mapping data, transformation data, assemble order data and index files used during creation of the original biometric SPBF file and select the same feature blocks and perform any transformations and assembly that were performed during the original storage.

At step 1106, the system can extract the SPBF biometric vector using the same biometric vector extraction routine as when the biometric vector was extracted during storage.

At step 1108, the system can compare the SPBF biometric vector file with the stored SPBF biometric vector file.

At step 1110, the system can return the results of the comparison, i.e., a match or no match and use that result for the biometric portion of an authentication routine.

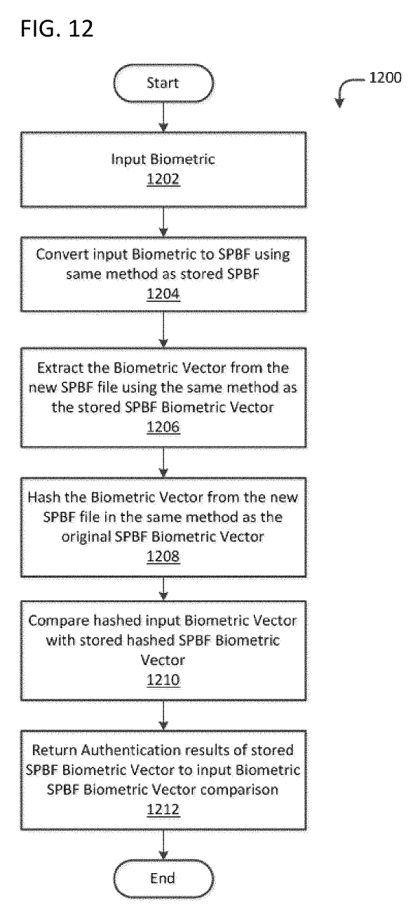

FIG. 12 shows an exemplary process for biometric authentication using a hashed biometric vector file. In this process, steps 1202, 1204 and 1206 are the same as steps 1102, 1104 and 1106 of FIG. 11.

Then, at step 1208, the system may hash the biometric vector file obtained from the newly formed SPBF (e.g., newly obtained from the user) using the same hash function as used in storing the originally obtained SPBF biometric vector.

At step 1210, the system may compare the SPBF biometric hash file with the stored biometric SPBF hash file.

At step 1212, the system may return the results of the comparison, i.e., a match or no match and use that result for the biometric portion of an authentication routine.

There are innumerable applications of a secure storage system such as disclosed herein. In one such application, system 100 may be configured to receive one or more identifiers in connection with one or more requests to verify an identity of one or more individuals. The system may respond to such a request by use of an identity verification component 120 shown in FIG. 1. For example, the first identifier discussed above may be received in connection with a request to verify an identity of the first individual. Requests for identity verification may be provided in connection with and/or related to financial transactions, information exchanges, and/or other interactions. Requests may be received from other individuals and/or other third parties.

System 100 may be configured to extract the biometric data associated with the one or more individuals from the corresponding storage addresses. For example, the first biometric data associated with the first individual may be extracted from the first storage address. Extracting information (e.g., biometric data) from a storage address may include decrypting information.

According to some implementations, system 100 may be configured such that, responsive to receiving the request to verify the identity of the first individual, a prompt may be provided to the first individual for biometric data matching the first biometric data and a private key matching the first private key. The prompt may be conveyed via a computing platform 104 associated with the first individual. The prompt may be conveyed via a graphical user interface and/or other user interface provided by the computing platform 104 associated with the first individual. The prompt may include an indication that is one or more of visual, audible, haptic, and/or other indications.

In some implementations, system 100 may be configured such that, responsive to receiving the request to verify the identity of the first individual, a prompt may be provided to a computing platform 104 associated with the first individual. The prompt may cause the computing platform 104 to automatically provide, to server(s) 102, biometric data matching the first biometric data and/or a private key matching the first private key.

System 100 may be configured to verify the identity of the one or more individuals upon, or in response to, receiving matching biometric data and private keys. For example, the personal identity of the first individual may be verified upon receipt of (i) biometric data matching the first biometric data and (ii) a private key matching the first private key. Verifying the personal identity of the first individual may include comparing stored information with newly received information. According to some implementations, identity system 100 may be configured such that the personal identity of the first individual may be verified upon receipt of (i) biometric data matching the first biometric data or the second biometric data and (ii) a private key matching the first private key. Such implementations may provide so-called “M-of-N” signatures for identity verification where some subset of a larger set of identifying information is required.

In some implementations, system 100 may be configured such that the biometric data matching the first biometric data and the private key matching the first private key may be used to sign the smart contract for verification of the personal identity of the first individual.

In some implementations, at least one dedicated node performs the signing of the smart contract for verification of the personal identity of the first individual or user. A given dedicated node may include one or more of server(s) 102. The given dedicated node may be a public node or a private node configured for creating new transactions and/or for signing the smart contracts for verification.

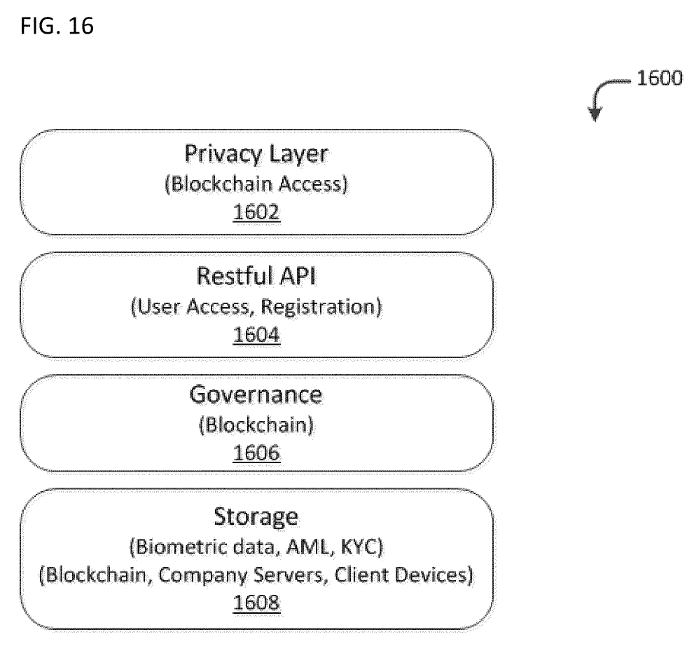

FIG. 16 shows an exemplary applied blockchain overview 1600, in accordance with one or more implementations. As shown, a privacy layer 1602 which may function as a permissioning administration layer for blockchain access, distributed ledger access or distributed database access may be used. It may be built on, for example, an Ethereum blockchain, e.g., blockchain or a Hyperledger distributed Ledger, e.g., distributed ledger 1606 for governance. As shown, there may be a mechanism for the storage of files (e.g., biometric data and other files). These items may be coupled with an application programming interface (API) 1604 such as a restful API, and e.g., a blockchain database 1608 to provide and/or enhance storage, such as BigChainDB. This may be coupled with, for example, a biometric app and a website, among other things. Other configurations may be used.

Exemplary implementations may facilitate access to personal data. There may be multiple access levels for the personal data in the block chain. Access controls may be granted on public/private key pairs levels. Examples of access levels may include one or more of Super Admin (full access to blockchain), Authorities-country level (full read-only access), Authorities-state/local level (limited read-only access), Police and other services including Emergency (access to certain personal data by Finger Print/Eye retina of that person only), Participating Merchants (limited access), and/or other access levels.

These aspects may be related to the mobile data that can be processed, collated, and/or held within the blockchain (whether in regard to the biometric identity of an individual and/or client).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system for providing a secure storage of electronic material, the system comprising:
a hardware processor configured to receive and securely store, a file of intelligible electronic information associated with the user, and upon receiving the file of electronic information, form fragments of the file of electronic information comprising at least a first fragment and a second fragment thereof;
a distributed data storage system having multiple nodes for storing blocks of information in a first non-transitory storage device;
a second non-transitory storage device that is outside the distributed data storage system; and
wherein the processor is further configured to store at least the first fragment of the file in the distributed data storage system, and to store at least the second fragment of the file outside the distributed data storage system
wherein the processor is configured to receive, as the electronic information, a graphics or image file in association with the user, which graphics or image file contains biometric graphics or images relating to the user, and to divide the graphics or image into a set of feature blocks of the graphics or image, create a mapping file to map the location of the feature blocks making up the graphics or image, store at least a first one of the feature blocks in the distributed data storage system, and store at least a second one of the feature blocks outside of the distributed data storage system, and
wherein the processor is configured to transform at least the first one and the second one of the feature blocks prior to storing the first one and the second one of the feature blocks, and to store the transformations in the mapping file.

2. The system of claim 1, wherein the processor is configured to create a mapping file to store location data for the at least first fragment and the at least second fragment of the file, including assembly data for the at least first fragment and the at least second fragment of the file, and to store the mapping file or at least a portion of the mapping file in distributed ledger storage.

3. The system of claim 1, wherein each of the fragments of the file are unintelligible unless partially or fully reassembled back into the file.

4. (canceled)

5. The system of claim 1, wherein the processor is configured to receive, as the file, a digital file associated with the user.

6. The system of claim 1, wherein the distributed data storage system is a trust utility for storage of immutable data.

7. (canceled)

8. (canceled)

9. The system of claim 1, wherein the processor is configured to split the mapping file into at least a first mapping file fragment and a second mapping file fragment, to store at least the first mapping file fragment in the distributed data storage system, and to store at least the second mapping file fragment outside of the distributed data storage system.

10. The system of claim 1, wherein the processor is configured to encrypt at least the first one of the feature blocks and at least the second one of the feature blocks.

11. The system of claim 9, wherein the processor is configured to encrypt at least the first one of the feature blocks and at least the second one of the feature blocks.

12. The system of claim 1, wherein the processor is configured to encrypt at least the mapping file.

13. The system of claim 1, wherein the set of feature blocks is a subset of the feature blocks that form the graphics or image.

14. The system of claim 1, wherein the graphics or image file is a file containing at least some biometric information associated with the user.

15. The system of claim 13, wherein the processor is configured to encrypt the subset of the feature blocks, break up the encrypted subset of feature blocks into at least a first fragment and a second fragment and store at least the first fragment in the distributed data storage system and at least the second fragment outside of the distributed data storage system.

16. The system of claim 13, wherein the processor is configured to create a hash of the subset of the biometric graphics and store at least a part of the hash in the distributed data storage system and at least another part of the hash outside of the distributed data storage system.

17. The system of claim 15, wherein the processor is configured to, in response to a user request for access to stored information in the system associated with the user, authenticate the user prior to granting access, including comparing at least a portion of a hash of a biometric graphics file newly received by the system from the user with a hash reassembled from the obtained from the at least first fragment from in the distributed data storage system and the at least second fragment from outside of the distributed data storage system, a positive match being required as at least part of authenticating the user, and wherein the processor is configured to, in response to a user request for access to stored information in the system associated with the user, authenticate the user prior to granting access, including comparing the subset of the feature blocks of the biometric graphics with a file a corresponding subset of feature blocks of a newly received biometric file by the system from the user, a positive match being required as at least part of authenticating the user.

18. The system of claim 13, wherein the subset of the feature blocks are one of contiguous blocks from the biometric graphics and non-contiguous blocks grouped together.

19. The system of claim 13, wherein feature blocks in the subset of the feature blocks are transformed prior to storage.

20. The system of claim 7 1, wherein the processor is configured to store a second graphics or image file in association with the user, and to divide the graphics or image in the second graphics or image file into a set of feature blocks, create a mapping file to map the location of the feature blocks making up the graphics or image, store at least a first one of the feature blocks in the distributed data storage system, and store at least a second one of the feature blocks outside of the distributed data storage system.

21. The system of claim 17, wherein the processor is configured to store a second graphics or image file in association with the user, and to divide the graphics or image in the second graphics or image file into a set of feature blocks, create a mapping file to map the location of the feature blocks making up the graphics or image, store at least a first one of the feature blocks in the distributed data storage system, and store at least a second one of the feature blocks outside of the distributed data storage system.

22. The system of claim 1, wherein the processor is further configured by the machine-readable instructions to create an index file of how the fragments fit back together to reassemble the file.

23. The system of claim 22, wherein the processor is further configured to form fragments of the index file comprising at least a first fragment and a second fragment thereof;
store at least the first fragment of the index file in a distributed data storage system; and
store at least the second fragment of the index file outside of the distributed data storage system.

24. The system of claim 1, wherein the processors are further configured to form at least a third fragment of the file, and to store the third fragment in the distributed data storage system separately from the first fragment stored in the distributed data storage system.

25. The system of claim 1, wherein the processors are further configured to store at least the first fragment as a transaction in the distributed data storage system.

26. The system of claim 24, wherein the processor is further configured to store at least the first fragment and the third fragment as separate transactions in the distributed data storage system.

27. The system of claim 1, wherein the processor is further configured by the machine-readable instructions to reassemble the file from the file fragments in response to a request from the user.

28. The system of claim 1, wherein the processor is further configured by the machine-readable instructions to form the first file fragment with at least a portion of the file header.

29. The system of claim 1, wherein the off blockchain storage is a digital storage device without its own CPU.

30. The system of claim 1, wherein the distributed data storage is a decentralized ledger storage.

31. A system for providing a secure storage of electronic material, the system comprising:
a hardware processor configured to receive and securely store, a file of intelligible electronic information associated with the user, and upon receiving the file of electronic information, form fragments of the file of electronic information comprising at least a first fragment and a second fragment thereof;
a distributed data storage system having multiple nodes for storing blocks of information in a first non-transitory storage device;
a second non-transitory storage device that is outside the distributed data storage system; and
wherein the processor is further configured to store at least the first fragment of the file in the distributed data storage system, and to store at least the second fragment of the file outside the distributed data storage system,
wherein the processor is configured to receive, as the electronic information, a graphics or image file in association with the user, and to divide the graphics or image into a set of feature blocks of the graphics or image, create a mapping file to map the location of the feature blocks making up the graphics or image, and to encrypt at least a first one of the feature blocks and a second one of the feature blocks, and to store at least the first one of the feature blocks in the distributed data storage system, and store at least the second one of the feature blocks outside of the distributed data storage system.

32. The system of claim 31, wherein the graphics or image file is a file containing at least some biometric information associated with the user.

33. The system of claim 32, wherein the processor is configured to create a hash of the subset of the biometric graphics and store at least a part of the hash in the distributed data storage system and at least another part of the hash outside of the distributed data storage system.
